(19) United States
(12) Patent Application Publication
(10) Pub. No.: US 2026/0169464 A1
(43) Pub. Date: Jun. 18, 2026

(54) OPERATION CONDITION DECISION SUPPORT SYSTEM, AND OPERATION CONDITION DECISION SUPPORT METHOD

(71) Applicant: NGK INSULATORS, LTD., Nagoya-shi (JP)

(72) Inventor: Masafumi MORI, Kariya-shi (JP)

(21) Appl. No.: 19/384,202

(22) Filed: Nov. 10, 2025

(30) Foreign Application Priority Data
Dec. 17, 2024 (JP) 2024-221200

(51) Int. Cl. G05B 19/4155

(52) U.S. Cl. CPC G05B 19/4155; G05B 2219/49018

(57) ABSTRACT

A system stores data representing a characteristic value obtained about each of one or more characteristic items related to a treatment result of the treatment target object, for each of a plurality of different treatment units with which a plurality of different operation conditions are associated, with respect to the treatment unit treated by the treatment apparatus according to an operation condition associated with the treatment unit. The system constructs a model for deriving the operation condition that satisfies the intended characteristic value with respect to each characteristic item, based on a dataset that includes data representing a condition value for each operation item in the operation condition, and data representing the characteristic value with respect to each characteristic item, for each of the treatment units.

### CROSS-REFERENCE TO PRIOR APPLICATION

This application relates to and claims the benefit of priority from Japanese Patent Application number 2024-221200, filed on December 17, 2024 the entire disclosure of which is incorporated herein by reference.

### BACKGROUND

The present invention generally relates to a technique for supporting decision of the operation conditions for a treatment apparatus that applies a treatment to a treatment target object.

A technique has been known that stores a powdered material (e.g., powder of a lithium-ion battery positive-electrode material) for the electronics industry in a square-shaped container that is called a saggar, conveys the saggar in a continuous furnace, such as a tunnel furnace, using a roller conveyor or the like, and fires the powdered material in the saggar. The operation of the continuous furnace is performed according to the operation conditions. The operation conditions include values (condition values) for each of one or more operation items (e.g., the temperature of a heater, and the airflow rate of gas).

Typically, the operation conditions for the continuous furnace largely depend on the experience and feeling of a person in charge. Trial and error for the operation conditions are repeated, and then the operation conditions are finally decided.

The operation conditions affect the sintered result (typically, the quality and performance of the sintered powdered material). That is, one or more operation items in the operation conditions correspond to at least part of influencing factors that affect the sintered result.

As for the operation of the treatment apparatus, such as a continuous furnace, for example, techniques described in WO2019/049669, JP2013-134676, and JP2022-010199 have been known. WO2019/049669 discloses evaluation based on the comparison between individual monitoring data and a threshold. JP2013-134676 discloses the operation of each of the same type of apparatuses using apparatus parameters common to the apparatuses. JP2022-010199 discloses that a regression model where measurement data items at previous time points are adopted as the explanatory variable, and a predetermined indicator is adopted as a response variable is constructed, and a predicted value of the indicator is calculated by inputting the measurement data items into the regression model.

### SUMMARY

The continuous furnace is an example of a treatment apparatus having the following characteristics (a) and (b).

(a) it is difficult to evaluate the quality or the performance of a treatment target object during treatment of the treatment target object (for example, during sintering). Consequently, the operation is performed from the treatment initiation to the treatment completion according to the operation conditions decided before the treatment of the treatment target object.

(b) The operation conditions have time constraints. For example, for an operation item that is the temperature of a heater and an operation item that is the airflow rate of gas, there is a constraint that a furnace temperature of X°C or more, and a gas concentration of Y% in the furnace are maintained for Z hours. That is, the operation conditions change over time.

None of WO2019/049669, JP2013-134676, and JP2022-010199 discloses or suggest a technique for supporting decisions of the optimal operation conditions that change over time, with respect to a treatment apparatus having such characteristics.

A system stores data representing a characteristic value obtained about each of one or more characteristic items related to a treatment result of a treatment target object, for each of a plurality of different treatment units with which a plurality of different operation conditions are associated, with respect to the treatment unit treated by a treatment apparatus according to the operation conditions associated with the treatment unit. The system constructs a model for deriving the operation conditions that satisfy the intended characteristic value with respect to each characteristic item, based on a dataset that includes data representing a condition value for each operation item in the operation conditions, and data representing the characteristic value with respect to each characteristic item, for each of the treatment units.

The present invention can support the decision of the optimal operation conditions that change over time with respect to the treatment apparatus that operates from the treatment initiation to the treatment completion for the treatment target object according to the operation conditions.

### BRIEF DESCRIPTION OF THE DRAWINGS

FIG. 1 shows a top view showing a schematic configuration of a heat treatment system according to an embodiment;

FIG. 2 is a block diagram showing a control system of the heat treatment system;

FIG. 3 is a block diagram showing a schematic configuration of a management apparatus;

FIG. 4A is a schematic perspective view showing an example of a treatment unit;

FIG. 4B is a schematic perspective view showing another example of a treatment unit;

FIG. 5 is a flowchart of an operation condition decision support process;

FIG. 6 is a configuration diagram of an operation condition DB;

FIG. 7 is a configuration diagram of a treatment history DB;

FIG. 8 is a schematic view of an example of a time series of measurements with respect to each measurement item; and

FIG. 9 is a schematic view of an example of a concept of label assigning and model construction.

### DETAILED DESCRIPTION

In the following description, "interface device" may be one or more interface devices. The one or more interface devices may be at least one of one or more I/O (Input/Output) interface devices and one or more communication interface devices. Each of the one or more I/O (Input/Output) interface devices is an interface device for at least one of an I/O device and a remote display computer. The I/O interface device for the display computer may be a communication interface device. At least one I/O device may be any of user interface devices, for example, an input device, such as a keyboard and a pointing device, and an output device, such as a display device. The one or more communication interface devices may be one or more communication interface devices of the same type (e.g., one or more NICs (Network Interface Cards)), or two or more communication interface devices of different types (e.g., an NIC and an HBA (Host Bus Adapter)).

In the following description, "memory" may be one or more memory devices that are examples of one or more storage devices, and typically, a main memory device. At least one memory device in the memory may be a volatile memory device, or a nonvolatile memory device.

In the following description, "persistent storage device" may be one or more persistent storage devices that are examples of one or more storage devices. Typically, the persistent storage device may be a nonvolatile storage device (e.g., an auxiliary storage device), and may be, specifically, for example, an HDD (Hard Disk Drive), an SSD (Solid State Drive), an NVME (Non-Volatile Memory Express) drive, or an SCM (Storage Class Memory).

In the following description, "storage device" may be at least the memory selected from the memory and the persistent storage device.

In the following description, "processor" may be one or more processor devices. At least one processor device is, typically, a microprocessor device, such as a CPU (Central Processing Unit), but may be another type of processor device, such as a GPU (Graphics Processing Unit). At least one processor device may be a single- core one or a multi-core one. At least one processor device may be a processor core. At least one processor device may be a processor device in a broad sense that performs part or all of the process (e.g., an FPGA (Field-Programmable Gate Array), a CPLD (Complex Programmable Logic Device), or an ASIC (Application Specific Integrated Circuit)).

In the following description, information through which an output is obtained in response to an input is sometimes described with representation such as "xxx table". This information may be data having any structure (for example, structured data or unstructured data), a neural network that generates an output in response to an input, a learning model typified by a genetic algorithm and a random forest. Consequently, "xxx table" can also be called "xxx information". In the following description, the configuration of each table is an example. One table may be divided into two or more tables. All or part of two or more tables may be integrated as one table.

In the following description, a function is sometimes described with representation of "yyy unit". The function may be realized by execution of one or more computer programs by a processor, implemented by one or more hardware circuits (e.g., an FPGA or an ASIC), or implemented by a combination of them. When the functions are implemented by the program being executed by the processor, a predetermined process is performed using the storage device, the interface device and/or the like as appropriate. Accordingly, the functions may be regarded as at least part of the processor. A process described using a function as a subject may be a process that the processor or an apparatus including the processor performs. The program may be installed from a program source. The program source may be, for example, a program distributing computer or a computer-readable recording medium (e.g., a non-transitory recording medium). Description of each function is an example, and a plurality of functions may be integrated into one function, or one function may be divided into a plurality of functions.

One embodiment is described below.

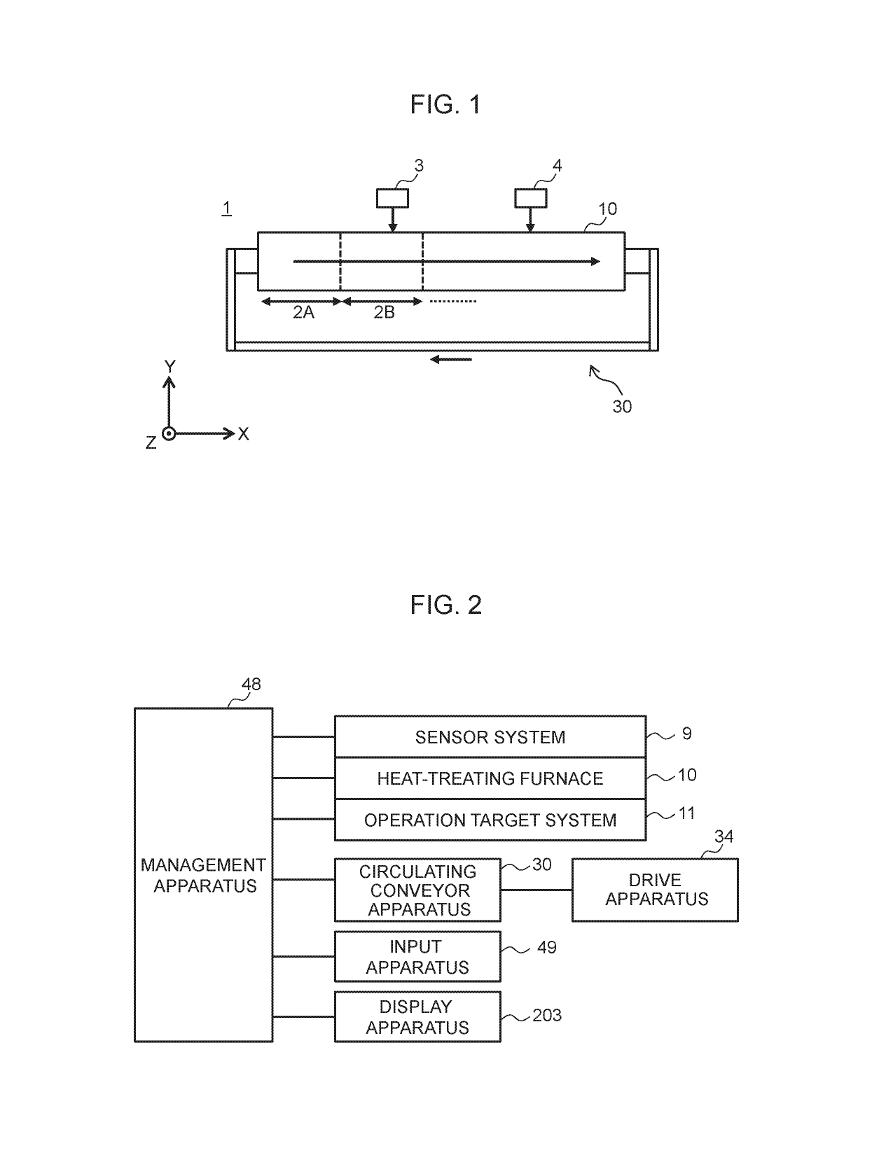

FIG. 1 shows a top view showing a schematic configuration of a heat treatment system according to an embodiment. FIG. 2 is a block diagram showing a control system of the heat treatment system.

As shown in FIG. 1, a heat treatment system 1 includes a heat-treating furnace 10, a circulating conveyor apparatus 30, and a management apparatus 48. As shown in FIG. 2, the management apparatus 48 is coupled to a heat-treating furnace 10, a sensor system 9, an operation target system 11, a circulating conveyor apparatus 30, an input apparatus 49, and a display apparatus 203.

The heat-treating furnace 10 applies a heat treatment to a treatment target object in a saggar 400.

In the present embodiment, a continuous type furnace (continuous furnace) that is a horizontal furnace is adopted. A roller hearth kiln may be adopted as the continuous type furnace. A heater, a roller conveyor (multiple rollers), and one or more partition walls may be provided in the heat-treating furnace 10. The partition walls may include an upper partition wall (e.g., a partition wall extending perpendicularly downward from the ceiling in the furnace) that is present above a conveyance surface of the roller conveyor, and a lower partition wall (e.g., a partition wall extending perpendicularly upward from the hearth in the furnace) that is present below the conveyance surface of the roller conveyor (an example of a conveyor mechanism). The presence of the partition walls in the longitudinal direction (conveyance direction) of the furnace may partition the inside of the heat-treating furnace 10 into a plurality of zones 2A, 2B,... (e.g., a temperature rising zone, a holding zone, and a cooling zone) arranged in the longitudinal direction (x direction) of the heat-treating furnace 10.

Gas flows into the heat-treating furnace 10 through a gas valve 3. The concentration of the gas is adjusted by controlling the gas valve 3. The concentration of the gas is measured by a gas analyzer 4. Note that in the present embodiment, for simplicity of description, the number of types of gas flowing into the furnace is one. However, multiple types of gas may flow into it.

In the heat treatment system 1, the saggar 400 (seeFIGS. 4A and 4B) is conveyed along an arrow. The heat treatment system 1 applies a heat treatment to a treatment target object 402 housed in the saggar 400. In the present embodiment, the treatment target object 402 housed in the saggar 400 is powder of a lithium-ion battery positive-electrode material. The heat treatment system 1 has a path along which the saggar 400 is circulated. Although not shown, the conveyance path (circulating path) may be provided with, besides the heat-treating furnace 10, a plurality of apparatuses, such as a saggar supply apparatus that supplies the saggar 400, a material supply apparatus that supplies the treatment target object (i.e., powder) into the saggar 400, a material collection apparatus that collects the treatment target object subjected to the heat treatment in the heat-treating furnace 10 from the saggar 400, a saggar cleaning apparatus that cleans the inner surface of the saggar 400 after the powder has been collected in the material collection apparatus, a saggar collection apparatus that collects the saggar 400, and a crack detection apparatus that detects a crack on the saggar 400.

The sensor system 9 for the heat-treating furnace 10 may be one or more sensors that measure one or more measurement items pertaining to the inside of the furnace, and may include, for example, a sensor for the temperature of the heater in the heat-treating furnace 10, and the gas analyzer 4 that measures the concentration of gas.

The operation target system 11 for the heat-treating furnace 10 may include one or more apparatuses controlled according to the operation conditions, for example, the heater and the gas valve 3 in the heat-treating furnace 10. The operation target system 11 may include one or more apparatuses controlled according to other conditions different from the operation conditions, for example, a roller conveyor.

The circulating conveyor apparatus 30 conveys the saggar 400 unloaded from an unloading port of the heat-treating furnace 10, to a loading port of the heat-treating furnace 10. The circulating conveyor apparatus 30 includes a plurality of conveyor rollers (not shown), and a drive apparatus 34. The plurality of conveyor rollers constitute the path of the saggar 400 from the unloading port of the heat-treating furnace 10 to the loading port of the heat-treating furnace 10. The plurality of conveyor rollers are arranged in the conveyance direction at a regular pitch and regular intervals. Each conveyor roller is rotatably supported around its axis, and is rotated by transmission of the drive force of the drive apparatus 34 (e.g., a motor). When the drive force of the drive apparatus 34 is transmitted to the conveyor rollers via the power transmission mechanism (e.g., a mechanism including sprockets and a chain), the conveyor rollers rotate. Note that the circulating conveyor apparatus 30 is not necessarily limited to the roller conveyor that conveys the saggar 400 with the conveyor rollers. The apparatus is only required to have a configuration that conveys the saggar 400 unloaded from the unloading port of the heat-treating furnace 10 to the loading port of the heat-treating furnace 10.

The management apparatus 48 controls the operations of the heat-treating furnace 10 (specifically, the operation target system 11 for the heat-treating furnace 10) and the circulating conveyor apparatus 30. The management apparatus 48 receives the measurements of one or more measurement items from the sensor system 9. The management apparatus 48 receives the input of data from the input apparatus 49, and causes the display apparatus 203 to display the data. Each of the input apparatus 49 and the display apparatus 203 may be a user interface apparatus. A touch panel that integrally includes the input apparatus 49 and the display apparatus 203 may be adopted. At least part of the management apparatus 48 may be a server. The input apparatus 49 and the display apparatus 203 may be clients.

According to the present embodiment, in the heat treatment system 1 described above, the decision of the operation conditions for the heat-treating furnace 10 is supported. The support for deciding the operation conditions is described in detail below.

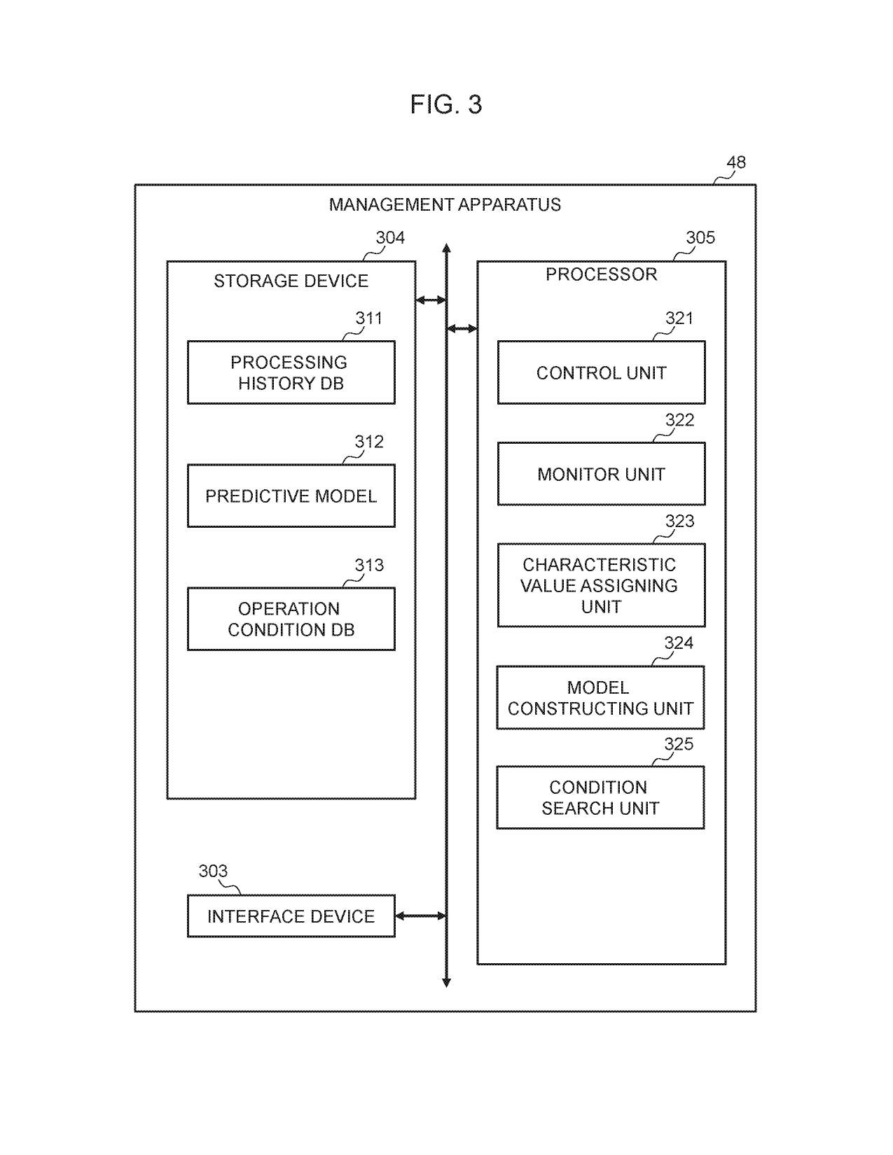

FIG. 3 is a block diagram showing a schematic configuration of the management apparatus 48.

The management apparatus 48 may be a physical computational machine system (e.g., one or more physical computational machines), or a logical computational machine (e.g., one or more virtual computational machines) based on a physical computational machine system. In the present embodiment, the management apparatus 48 is a physical computational machine system. The management apparatus 48 includes an interface device 303, a storage device 304, and a processor 305 coupled to the devices 303 and 304.

The sensor system 9, the heat-treating furnace 10, the operation target system 11, the circulating conveyor apparatus 30, the input apparatus 49 and the display apparatus 203, and the management apparatus 48 communicate with each other via the interface device 303.

The storage device 304 stores data and programs. The data includes, for example, a treatment history DB (database) 311, a predictive model 312, and an operation condition DB 313. These data items 311 to 313 are described later.

The processor 305 has the functions of a control unit 321, a monitor unit 322, a characteristic value assigning unit 323, a model constructing unit 324, and a condition search unit 325, which are achieved by execution of the programs stored in the storage device 304. These functions 321 to 325 are described later.

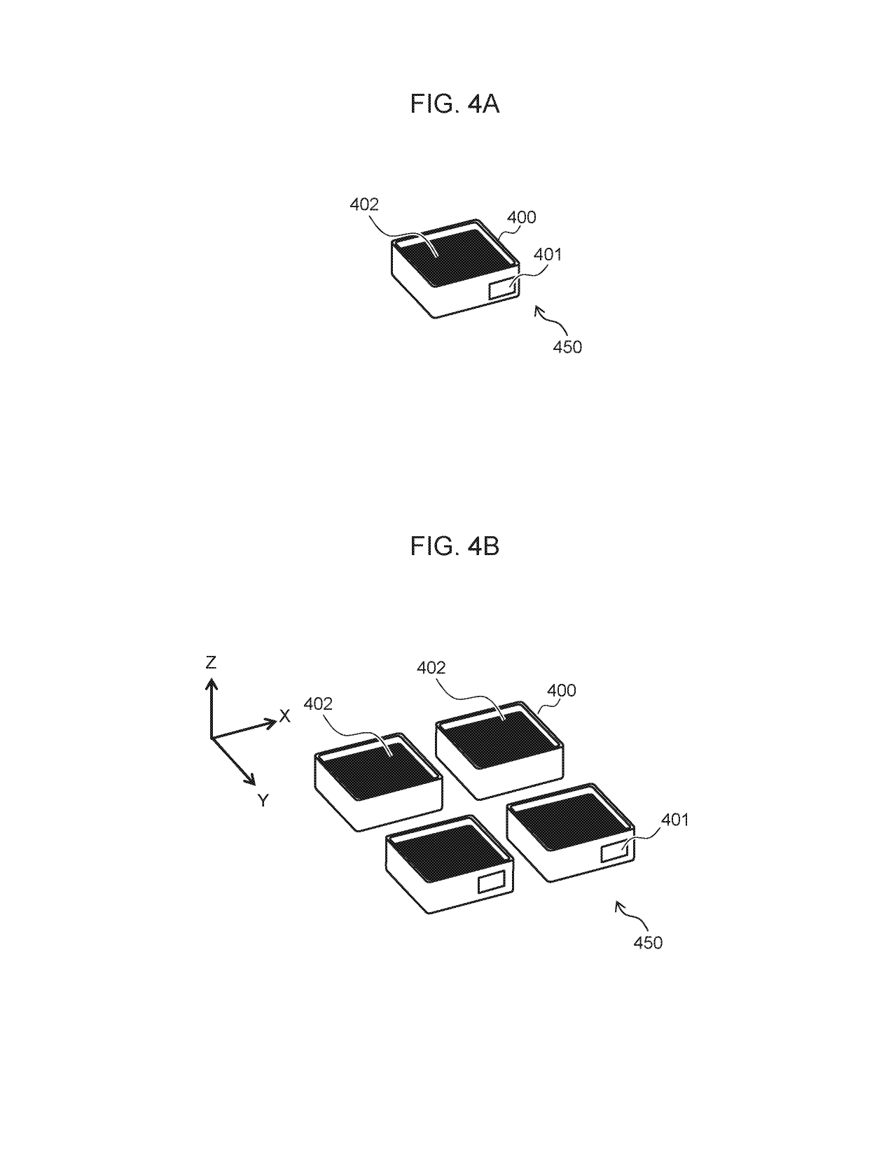

FIG. 4A is a schematic perspective view showing an example of a treatment unit. FIG. 4B is a schematic perspective view showing another example of a treatment unit.

A heat treatment is applied to a treatment unit 450 with respect to each zone 2. For example, a heat treatment for a first treatment unit 450 is performed in zone 2A. Next, the first treatment unit 450 having already been subjected to the treatment in the zone 2A is conveyed to a zone 2B and then a heat treatment for the first treatment unit 450 is performed in the zone 2B, and a second treatment unit 450 is conveyed to the zone 2A and then a heat treatment for the second treatment unit 450 is performed in the zone 2A.

The treatment unit 450 may be one saggar 400 that stores a treatment target object 402 as exemplified in FIG. 4Ain a certain case, or a plurality of saggars 400 that respectively store treatment target objects 402 as illustrated in FIG. 4B in another case. These saggars 400 may be arranged at least in one direction among an X direction (the conveyance direction), a Y direction (the depth direction orthogonal to the conveyance direction), and a Z direction (the height direction orthogonal to the conveyance direction). The saggar 400 that stores the treatment target object 402, in other words, the treatment target object 402 stored in the saggar 400 can be called a "workpiece".

Note that on an external surface (external wall surface) of the saggar 400 there may be an object 401 of data that represents a product number (an example of an ID) of a workpiece (e.g., a saggar 400). The object 401 may be a printed object applied on the saggar 400 using heat-resistant ink or the like, or a medium, such as seal, pasted using heat-resistant adhesive or the like. The "data representing the product number of the workpiece" may be represented by a barcode or a two-dimensional code (e.g., QR code(R)), or represented by text that is made up of alphanumeric or the like and represents the product number. The product number of the workpiece may be identified from data read from the object 401 by a reader apparatus, such as a code reader or a camera. Note that the object 401 is not necessarily included in the saggar 400. Accordingly, the reader apparatus for reading the object 401 is not necessarily included. For example, with respect to each saggar 400 provided on the conveyance path, data such as takt time may be managed with the monitor unit 322 to track the saggar on the conveyance path, thus allowing the product number of the saggar 400 to be identified.

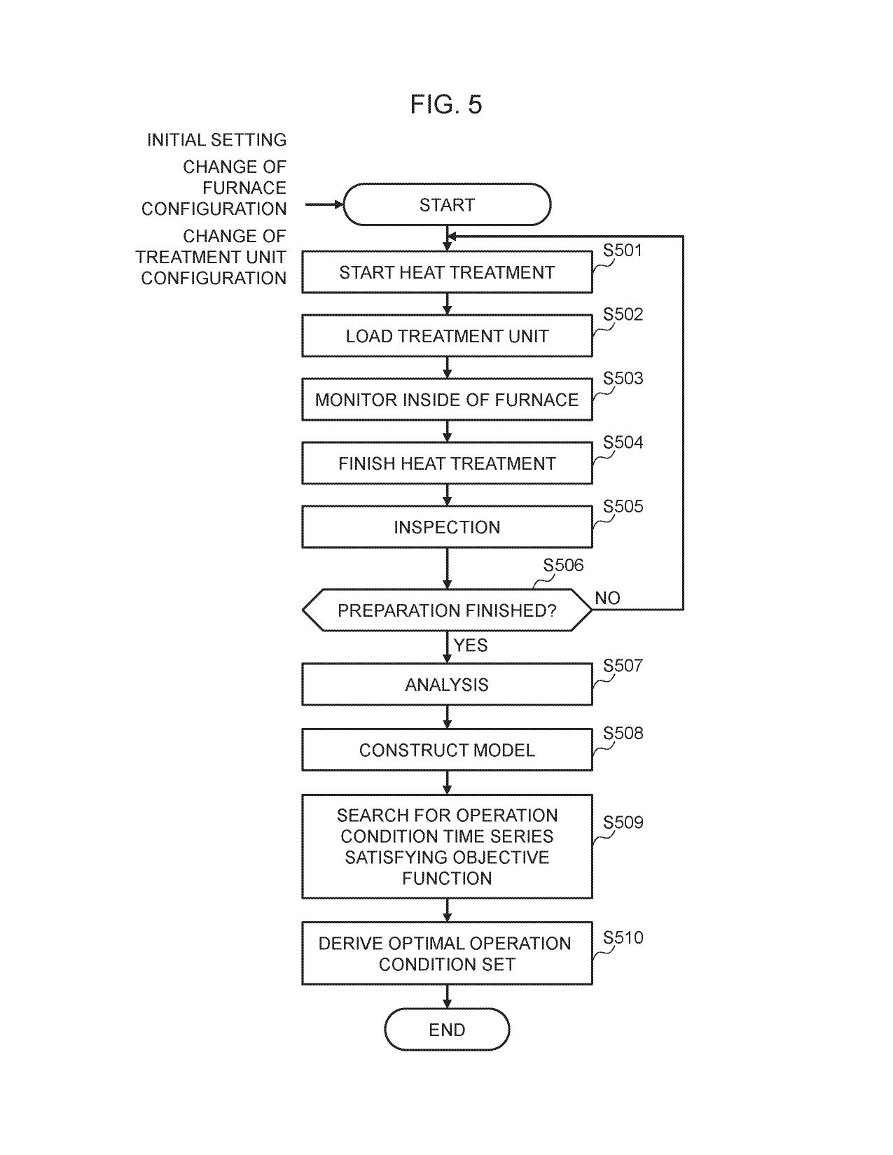

FIG. 5 is a flowchart of an operation condition decision support process.

In the operation condition decision support process, the predictive model 312 is constructed by analyzing data accumulated by the following repetition, and the optimal operation conditions are obtained using the predictive model 312.

Set default operation conditions, or update the set operation conditions.

Perform heat treatment according to the default or updated operation conditions.

Monitor the inside of the furnace during the heat treatment.

The details are described below.

The control unit 321 starts a heat treatment (S501). Specifically, the control unit 321 sets the default operation conditions, or updates the set operation conditions to different operation conditions, and starts the operation of the heat-treating furnace 10 (operation target system 11) according to the default or updated operation conditions. The operation conditions include condition values for each of one or more operation items from the start to end of the operation. The operation conditions may be updated according to a predetermined rule. For example, a rule of increasing or reducing the condition value by a predetermined value with respect to at least one operation item in the operation conditions having not been updated yet may be adopted as the predetermined rule.

Treatment units 450 each made up of a predetermined number of workpieces (saggars 400 that store treatment target objects 402) are sequentially placed on the conveyance path, and the treatment units are sequentially loaded through the loading port of the heat-treating furnace 10 (S502). The timing of starting loading may be when the monitor unit 322 monitors the state (e.g., the temperature and the gas concentration) in the furnace, based on data of each measurement from the sensor system 9, and detects that the state in the furnace is a state satisfying the operation conditions. In the present embodiment, for simplicity of description, the number of treatment units 450 treated with respect to one operation condition is one. That is, the relationship between the operation condition and the treatment unit 450 (after-mentioned treatment ID) is assumed to be 1:1.

In the operation for one operation condition, none of the following are changed during the operation. This is because if any one of the following is changed, there will be a possibility that the accuracy of the correlation between the operation condition and the treatment result (sintered result) obtained in S505 (inspection) described later cannot be maintained.

The configuration of the treatment unit 450. For example, the number and layout of workpieces.

The furnace configuration in the heat-treating furnace 10. For example, the number of zones, and the length of each zone in the conveyance direction.

The monitor unit 322 monitors the inside of the furnace (S503). That is, the monitor unit 322 accepts, from the sensor system 9, data of the measurement for each measurement item with respect to the treatment unit 450 loaded into the heat-treating furnace 10. The initiation timing of monitoring the inside of the furnace may be, for example, when a signal indicating that the treatment unit 450 is detected from a sensor that detects the treatment unit 450 approaching the loading port is received, or when an instruction of starting monitoring the inside of the furnace is received from an operator through the input apparatus 49 or a predetermined button. On the other hand, the completion timing of monitoring the inside of the furnace may be, for example, when a signal indicating that the treatment unit 450 is detected from a sensor that detects the treatment unit 450 unloaded from the unloading port is detected, or when an instruction for finishing monitoring the inside of the furnace is received from the operator through the input apparatus 49 or a predetermined button.

In S503, the monitor unit 322 may accumulate, in the treatment history DB 311, the product numbers of all the saggars 400 in the treatment unit 450, assign treatment IDs (e.g., serial numbers) to these product numbers, and accumulate the treatment IDs in the treatment history DB 311. The treatment ID identification may be performed before loading. Subsequently, the presence of the treatment units 450 with certain treatment IDs in certain zones 2 may be estimated based on control details, such as retention time period in each zone. The treatment ID may also be identified based on reading of the product number, with respect to each zone 2.

In S503, the monitor unit 322 may also accumulate the measurement with respect to each measurement item in the treatment history DB 311, for each time point identified by a timer or the like. Thus, in the treatment history DB 311, the time series of measurements with respect to each measurement item for each treatment unit 450 is accumulated.

When it is detected that the treatment unit 450 exits from the unloading port of the heat-treating furnace 10, the heat treatment is finished (S504). That is, the control unit 321 finishes the operation of the operation target system 11.

The treatment unit 450 unloaded from the heat-treating furnace 10 is taken out from the conveyance path by the operator or the apparatus for the sake of inspection, and for the treatment unit 450 having thus been taken out, the inspection of the quality and performance of each treatment target object 402 in the saggar 400 in the treatment unit 450 is performed (S505). Specifically, in S505, with respect to each treatment target object 402, for each of one or more characteristic items (inspection items), the inspection is performed, and the characteristic value depending on the inspection result is assigned by the characteristic value assigning unit 323. The inspection may be manually or automatically performed. For example, by analyzing a taken image of the treated treatment target object 402, the characteristic value of one characteristic among all of the one or more characteristics may be assigned. The characteristic value may be, for example, the measurement itself input from the inspection apparatus or the like, or a characteristic quantity based on the input measurement (e.g., a level to which the measurement corresponds among multiple stages of levels). Each of the characteristics is a response variable, and may be, for example, the specific surface area, crystallite diameter, pore diameter, or particle diameter, for the lithium-ion battery positive-electrode material.

The control unit 321 determines whether the condition for preparation completion is satisfied (S506). The condition for the preparation completion may be, for example, presence of sufficient data for analysis, specifically, for example, accumulation of data pertaining to a predetermined number of treatment units 450 or more (in other words, a predetermined number of operation conditions or more) in the treatment history DB 311. If the determination result in S506 is false (S506: NO), the processes in and after S501 are performed, i.e., the operation condition is updated, and the operation according to the updated operation condition (the heat treatment for a new treatment unit 450) is performed. Thus, with respect to each of different operation conditions, the time series of measurements for each measurement item, and the characteristic value, and the characteristic value for each of one or more characteristics as the treatment result(sintered result) are accumulated in the treatment history DB 311.

If the determination result in S506 is true (S508: YES), model constructing unit 324 analyzes the characteristic value for each characteristic item with respect to each treatment unit 450 (each operation condition), thereby assigning a label to each treatment unit 450 (S507). The assigned label may be any one of "good" (good quality product) and "bad" (bad quality product). Note that the combination of definitions of "good" and "bad" may be any one of the following (x) and (y). In the present embodiment, (y) is adopted. That is, in the present embodiment, instead of an alternative of finding operation conditions for generating a good treatment result, an alternative of finding operation conditions for generating no bad treatment result is adopted. This is because it is difficult to define a good treatment result, and it is more efficient to define a bad treatment result.

(x) "good" means that for the predetermined type or predetermined number of characteristics (e.g., at least one characteristic), the characteristic value satisfies a condition for a good treatment result (favorable about the quality or performance). "Bad" means that it does not correspond to "good".

(y) "bad" means that for the predetermined type or predetermined number of characteristics (e.g., at least one characteristic), the characteristic value satisfies a condition for a bad treatment result (problematic about the quality or performance). "Good" means that it does not correspond to "bad".

The model constructing unit 324 constructs the predictive model 312 that adopts the operation condition for each operation item in the operation conditions as the explanatory variable, and adopts the characteristic value for each characteristic item as the response variable, based on each characteristic value for each treatment unit 450 assigned "good", and the operation condition for each treatment unit 450 assigned "good" (S508).

The predictive model 312 may be any one of a statistical model, a machine learning model, or the like. Specifically, for example, linear regression (e.g., ridge regression, lasso regression, elastic net regression), logistic regression, SVM (Support Vector Machine), decision tree model (e.g., random forest, XGBoost (Xtreme Gradient Boosting), Light GBM (Light Gradient Boosting Machine)), neural network (e.g., CNN, RNN (Recurrent Neural Network), ResNet (Residual Network)), Bayesian optimization, k-NN (k-Nearest Neighbor), or a combination of freely selected two or more models among them. In the present embodiment, a neural network-based model is adopted. That is, in the present embodiment, supervised learning where a dataset including data for each treatment unit 450 assigned "good" (data including a combination of the characteristic value for each characteristic item, and the operation condition) is adopted as a teacher dataset is performed for a neural network-based model, thereby constructing the predictive model 312 as a trained model.

The teacher dataset used to construct the predictive model 312 may include the time series of measurements for each measurement item with respect to each treatment unit 450 assigned "good", and may include the time series of measurements for each measurement item with respect to each treatment unit 450 assigned "bad". For example, in what is called multivariate time series analysis, the model constructing unit 324 may identify one or more causes assigned "bad", based on the measurement time series for each measurement item with respect to each treatment unit assigned "bad" and on the measurement time series for each measurement item with respect to each treatment unit assigned "good". The "cause" described here may be characteristics related to the measurement for one or more measurement items in a common time interval among measurement time series for each measurement item with respect to each treatment unit assigned "bad". The "cause" substantially corresponds to the boundary between "good" and "bad" although "bad" is assigned by reference to the measurement time series for each measurement item with respect to each treatment unit assigned "good". The model constructing unit 324 estimates the condition value for the operation item that affects the measurement change pattern as the cause, based on the relationship between one or more identified causes and the operation conditions with respect to each treatment unit assigned "bad". The model constructing unit 324 constructs the predictive model 312 for deriving the operation conditions for preventing the identified one or more causes from occurring. The operation conditions derived from the predictive model 312 do not include the condition value for the operation item that affects the measurement change pattern as the cause of "bad". That is, the constructed predictive model 312 corresponds to the objective function for preventing fulfillment of a condition that the characteristic value indicates a bad treatment result with respect to the predetermined type or predetermined number of characteristics.

By inputting the operation conditions as the explanatory variables into the objective function, the characteristic value as the response variable is estimated. The condition search unit 325 uses the predictive model 312 to search for the operation conditions satisfying the objective function (allowing estimation of the characteristic value other than the characteristic value satisfying the condition that the predetermined type or predetermined number of characteristics indicate a bad treatment result) (S509).

Through this search, the condition search unit 325 derives the optimal operation condition satisfying the intended characteristic value, for each of the one or more characteristic items (S510). The "optimal operation condition" described in the present embodiment is an operation condition for preventing a bad treatment result from being obtained. The data representing the derived operation condition is stored from the condition search unit 325 into the operation condition DB 313. At least some of the operation conditions may be edited by the user. The derived operation conditions (or operation conditions edited by the user based on the operation conditions) are the optimal operation conditions used for an actual operation to treat the treatment target object.

The operation condition decision support process has thus been described above.

Note that the derived operation conditions may be displayed on the display apparatus 203 by the condition search unit 325.

The loop from S501 to S505 may be performed in a case where the model constructing unit 324 identifies that the accuracy of the predictive model 312 constructed in S508 does not satisfy the predetermined value in addition to or instead of a case where the determination result in S506 is false.

As for the operation condition decision support process shown in FIG. 5, this operation condition decision support process is executed, not only in the case of initial setting of the operation conditions, but also in a case where an event that the operation conditions can become inappropriate after the operation conditions are set (in other words, an event that the operation conditions cannot satisfy the objective function) occurs. Examples of such an event may include the change of the configuration of the inside of the heat-treating furnace 10, and the change of the configuration of the treatment unit 450. Specifically, for example, in a case of a user input through the input apparatus 49, or a case where the change of the configuration in the furnace or the change of the configuration of the treatment unit 450 is identified by the control unit 321 through a predetermined sensor or the like, the operation condition decision support process may be started by the control unit 321.

The configurations of the operation condition DB 313 and the treatment history DB 311 pertaining to the operation condition decision support process, and analysis and model construction are described in detail below.

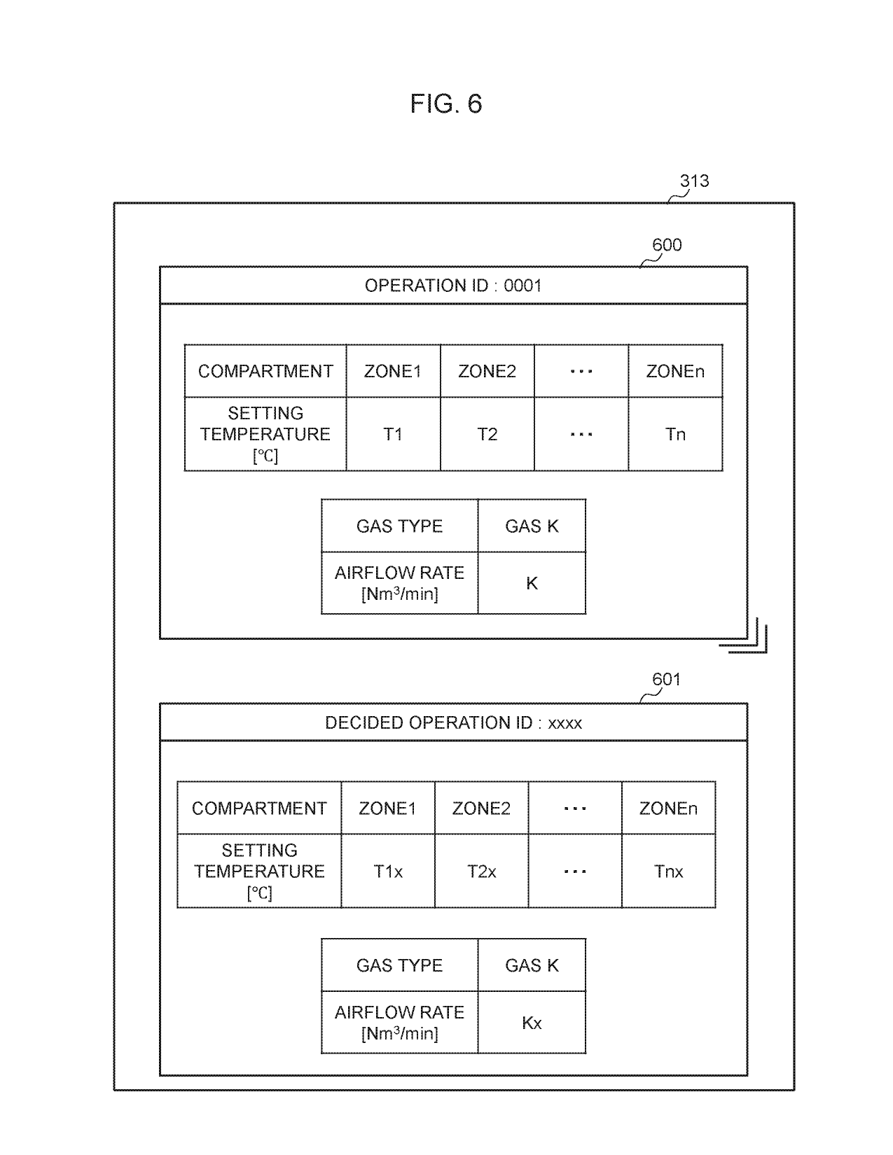

FIG. 6 is a configuration diagram of the operation condition DB 313.

In the operation condition DB 313, an operation condition table 600 is stored, for each operation condition used to derive the optimal operation conditions in the operation condition decision support process. The operation condition table 600 includes operation IDs as the IDs of the operation conditions, and further includes the time series of condition values for each of the operation items constituting the operation conditions. For each operation item, the time may be represented as the time point or represented as the zone. Data representing the time period for being present in the zone may be associated with each zone. For the operation item with the constant condition value irrespective of time, one condition value may correspond to the time series of the condition values. For at least one operation item, the operation conditions may include a plurality of pairs of the time and the condition value, as the condition value time series.

In the operation condition DB 313, the operation condition table 601 that represents the optimal operation conditions derived in the operation condition decision support process (or edited by the user) is stored.

According to the example shown in FIG. 6, the operation item of "setting temperature" may be the temperature of the heater in each zone. That is, for each zone, the condition value of the heater in the zone is fixed irrespective of time. With respect to the treatment target object 402 that sequentially moves over the zones, the time series of heater temperatures (an example of the condition value) is defined.

According to the example shown in FIG. 6, for the gas, the condition value for the operation item, i.e., the airflow rate, is constant irrespective of time.

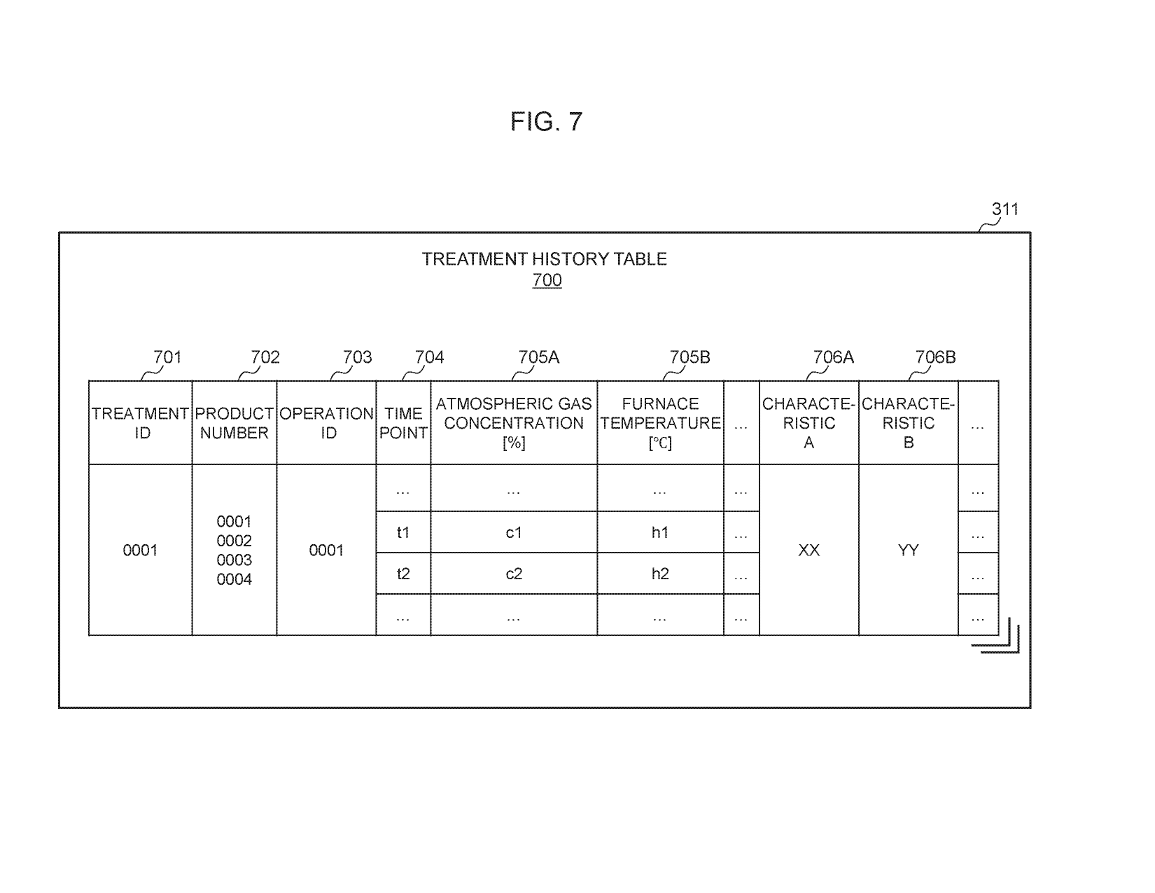

FIG. 7 is a configuration diagram of the treatment history DB 311.

The treatment history DB 311 includes the treatment history table 700 for each treatment unit 450. The treatment history table 700 includes data made up of a treatment ID 701, a product number 702, an operation ID 703, a time point 704, and measurements 705 (e.g., measurements 705A and 705B), and characteristic values 706 (e.g., characteristic values 706A and 706B).

The treatment ID 701 represents the ID of the treatment unit 450. The product number 702 represents the product number (ID) for each workpiece included in the treatment unit 450. The operation ID 703 represents the operation ID of the operation conditions applied to the treatment unit 450.

The time point 704 represents the time point of obtaining the measurement. The measurement 705 is present for each measurement item, and represents the measurement obtained with respect to the corresponding measurement item. According to the example shown in FIG. 7, the measurement items include the atmospheric gas concentration, and the furnace temperature.

The characteristic value 706 is present for each characteristic item, and represents the characteristic value assigned to the characteristic. The characteristic is a response variable, and may be, for example, the specific surface area, crystallite diameter, pore diameter, or particle diameter, for the lithium-ion battery positive-electrode material.

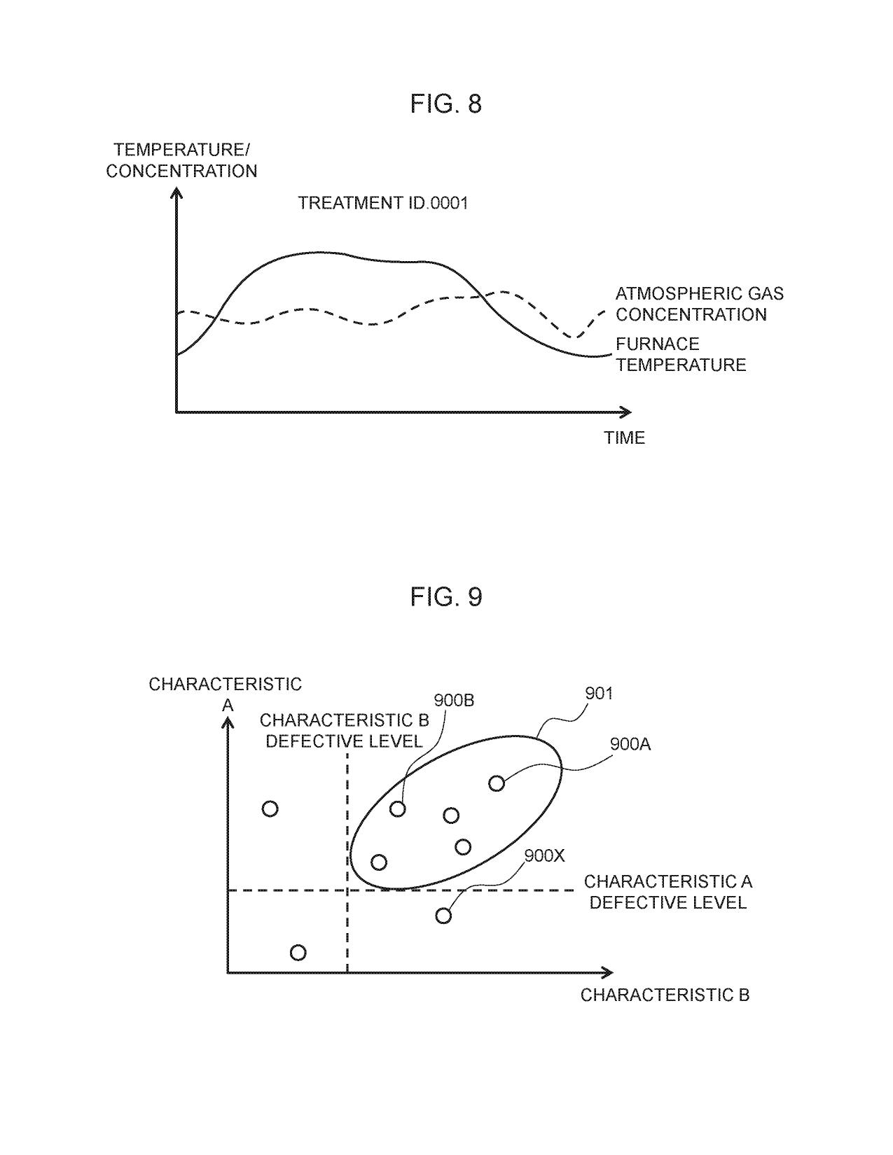

FIG. 8 is a schematic view of an example of the time series of measurements with respect to each measurement item. FIG. 9 is a schematic view of an example of a concept of label assigning and model construction.

The time series shown in FIG. 8 is a time series identified from the time point 704 and the measurement 705 in the treatment history table 700, and is an example about a certain treatment unit 450. For each of the treatment units 450, the time series shown in FIG. 8 is identified from the treatment history table 700 corresponding to the treatment unit 450. The temporal axis is common to the measurement items. Accordingly, for each treatment unit 450, a combination of measurement time series is obtained among the measurement items.

According to the example shown in FIG. 9, each treatment unit 450 is plotted at the corresponding position (a position to which the combination of the characteristic value of the characteristic A and the characteristic value of the characteristic B corresponds) on a plane of coordinates where the characteristic value of the characteristic A is adopted as the ordinate axis, and the characteristic value of the characteristic B is adopted as the abscissa axis. In the present embodiment, "good" is assigned to each of five treatment units 450 where each of the characteristic value of the characteristic A and the characteristic value of the characteristic B does not correspond to a defective level (less than a threshold). Accordingly, an objective function 901 that covers the five coordinates (e.g., coordinates 900A and 900B, etc.) of these five treatment units 450 is constructed as the predictive model 312. On the other hand, "bad" is assigned to the treatment unit 450 (e.g., the treatment unit 450 corresponding to a coordinate 900X) where at least one of the characteristic value of the characteristic A and the characteristic value of the characteristic B corresponds to the defective level (less than the threshold). The data of the treatment unit 450 assigned "bad" (e.g., the operation condition and the characteristic value for each characteristic item) is not necessarily used for model construction.

The embodiment described above can be integrally described as the following overview. The following overview may include supplementary description, description of modified examples and the like.

The operation condition decision support system as an example of the computational machine system is constructed. The operation condition decision support system may be the management apparatus 48, or a client-server system that includes one or more clients, and a server that communicates with the clients. The clients may be edge apparatuses, and the server may be a core apparatus.

The operation condition decision support system may include the characteristic value assigning unit (e.g., the characteristic value assigning unit 323) and the model constructing unit (e.g., the model constructing unit 324). For example, the operation condition decision support system may include an interface device, a storage device, and a processor (e.g., the interface device 303, the storage device 304, and the processor 305), and the characteristic value assigning unit and the model constructing unit may be implemented by a processor that executes programs.

The characteristic value for each characteristic item may be recorded with respect to each workpiece (product number). For model construction, with respect to one treatment unit, one characteristic value may be required for each characteristic item. In a case where the treatment unit includes a plurality of workpieces, with respect to the treatment unit, the characteristic value for each characteristic item may be a statistical value (e.g., the average or the maximum) of a plurality of characteristic values corresponding to the workpieces constituting the treatment unit.

The characteristic value assigning unit stores, in the storage device (e.g., the storage device 304), data representing the characteristic value obtained about each of one or more characteristic items related to the treatment result of the treatment target object (e.g., the treatment target object 402), for each of different treatment units (e.g., the treatment units 450) with which different operation conditions are associated, with respect to the treatment unit treated by the treatment apparatus (e.g., the heat-treating furnace 10) according to the operation conditions associated with the treatment unit. The model constructing unit 324 constructs a model (e.g., the predictive model 312) for deriving the operation conditions that satisfy the intended characteristic value with respect to each characteristic item, based on a dataset (e.g., treatment history DB 311) that includes data representing the condition value of each operation item in the operation conditions, and data representing the characteristic value with respect to each characteristic item, for each of the treatment units.

Accordingly, the decision of the optimal operation conditions that change over time with respect to the treatment apparatus that operates from the treatment initiation to the treatment completion for the treatment target object according to the operation conditions can be supported. Note that "intended characteristic value" designated for the model may be the characteristic value itself, or the condition for the characteristic value (for example, equal to or larger than a designated threshold).

The operation condition decision support system may include a condition deriving unit (e.g., a condition search unit 325). The condition deriving unit may derive the operation conditions that satisfy the intended characteristic value for each of the one or more characteristic items, using the constructed model.

The characteristic value assigning unit may assign the first label to the treatment unit, if for each of the treatment units, the characteristic value of the predetermined number or more or the predetermined type of the characteristic items among the one or more characteristic items satisfy a predetermined requirement. On the other hand, this unit may assign the second label to the treatment unit, if for the treatment unit, the characteristic value of the predetermined number or more or the predetermined type of the characteristic items among the one or more characteristic items do not satisfy the predetermined requirement. The dataset used for model construction may include data representing the label assigned to the treatment unit, with respect to each of the plurality of treatment units.

The first label may mean fulfillment of a condition that the characteristic values of the predetermined number or more or the predetermined type of the characteristic items indicate a bad treatment result. The second label may mean non-fulfillment of the condition that the characteristic values of the predetermined number or more or the predetermined type of the characteristic items indicate a bad treatment result. That is, instead of an alternative of finding operation conditions for generating a good treatment result, an alternative of finding operation conditions for generating no bad treatment result may be adopted. This is because it is difficult to define a good treatment result, and it is more efficient to define a bad treatment result. Typically, the "treatment result" may be the quality or performance of the treated treatment target object. For the model construction, data for each treatment unit assigned the second label may be used, and data for each treatment unit assigned the first label is not necessarily used. As described above, even with change of the treatment environment, such as the configuration of the treatment unit, the treatment target object (e.g., a material), or the configuration of the treatment apparatus, by constructing a model using a data group that does not result in a bad treatment result, it is expected to quickly construct a model for deriving the operation conditions suitable for the changed treatment environment.

The treatment apparatus includes a treatment chamber, and treats the treatment unit having entered the treatment chamber. The operation condition decision support system may also include the monitor unit (e.g., the monitor unit 322). With respect to each of the plurality of treatment units, for the treatment unit, the monitor unit may measure values by one or more sensors (e.g., the sensor system 9) about each of one or more measurement items concerning the inside of the treatment chamber (e.g., the inside of the furnace), and store the values in the storage device, during treatment according to the operation conditions associated with the treatment unit. The model constructing unit may construct the model, based on the dataset that includes the time series of measurements about each of the one or more measurement items with respect to each of the treatment units, besides data representing the operation conditions and the characteristic value for each characteristic item with respect to each treatment unit. Due to the cause that is facility deterioration or the like, even with the same operation conditions, the measurements in the treatment chamber can be different (for example, the temperature does not increase, the variation in gas concentration increases). That is, factors different from the set operation conditions affect the measurement in the treatment chamber, and can resultantly affect the characteristic value pertaining to the treatment result. Besides the operation conditions and the characteristic value with respect to each treatment unit, the measurement time series is reflected in the model construction. Accordingly, a more appropriate model is expected to be constructed from the relationship between the operation conditions and the characteristic value, and the measurement time series.

Specifically, for example, the model constructing unit may identify one or more causes assigned the first label, from data that includes a time series of measurements about each of measurement items with respect to each treatment unit assigned the first label, and data that includes a time series of measurements about each of the measurement items with respect to each treatment unit assigned the second label. Each of the one or more causes is a measurement characteristic with respect to one or more measurement items in a common time interval in a measurement time series about each measurement item with respect to each treatment unit assigned the first label. The model constructing unit may construct the model for deriving the operation conditions for preventing the one or more causes from occurring, based on the relationship between the one or more causes and the operation conditions with respect to each treatment unit assigned the first label. The first label may indicate that it is a bad treatment result, and the second label may indicate that it is not a bad treatment result. For example, the technical meaning of the model construction may be as follows.

That is, in a case where there are a plurality of treatment units assigned the first label (e.g., "bad"), a common measurement characteristic is expected to be present over one or more common time intervals with respect to the treatment units. The "time interval" is part of a time period from the initiation to completion of the heat treatment, and may be defined by a combination of the elapsed time period from the initiation of the heat treatment, and the time length from the elapsed time. The "measurement characteristic" may be the characteristic (e.g., the pattern) of the relationship between measurement time series for one or more measurement items, and specifically, may be defined by, for example, any one of increase, decrease, and absence of change, with respect to each of two or more measurement time series, or the amount of change. As described above, with the treatment units assigned the first label, the common measurement characteristic is expected to be present over one or more common time intervals. In other words, with the treatment units assigned the second label (e.g., "good"), it is expected that there is no combination of the common time interval present for the treatment units assigned the first label, and the measurement characteristic. A model where the operation conditions for preventing the cause assigned the first label from occurring is expected to be searched for can be constructed. Note that for model construction, a matrix may be adopted as the multivariate time series, the characteristic quantity may be extracted using, for example, a convolution neural network (CNN), and weighting for describing the characteristic value may be made based on the extracted characteristic quantity. The cause assigned the first label may be reflected as the weight for describing the characteristic value.

Due to a certain cause, increase in treatment time period can occur. For example, the treatment is stopped, and with respect to some treatment units, the treatment time period can increase. More specifically, with some treatment units, the retention time period in a certain zone can be long, while with other treatment units, the retention time period in another zone can be long. Even if the time period required for the treatment for the treatment unit increases with respect to each treatment unit, the measurement time series for each measurement item is associated with the treatment unit. Even the measurement time series with the increased treatment time period can be useful to identify the cause assigned the first label.

Note that reference data that represents the (for example, ideal or permissible) measurement time series or its characteristics for reference may be stored in the storage device with respect to each measurement item. The operation conditions derived using the constructed model (or partially edited operation conditions thereof) may be set. While the operation according to the set operation conditions is performed for each of the treatment units, the monitor unit may compare the measurement time series (or its characteristic) obtained for each measurement item with the reference data described above with respect to each treatment unit. If the obtained difference between the measurement time series (or its characteristic) and the measurement time series (or its characteristic) represented by the reference data is larger than a predetermined difference, the model is reconstructed. By searching for the operation conditions using the reconstructed model, or tuning the set operation conditions, an operation condition allowing the obtained difference between a measurement time series (or its characteristic) and the measurement time series (or its characteristic) represented by the reference data to be less than a predetermined difference may be derived and set.

1. An operation condition decision support method of supporting decision of an operation condition for a treatment apparatus that applies a treatment to one or more treatment target objects included in a treatment unit, the method causing a computer to perform:
(A) storing data representing a characteristic value obtained about each of one or more characteristic items related to a treatment result of the treatment target object, for each of a plurality of different treatment units with which a plurality of different operation conditions are associated, with respect to the treatment unit treated by the treatment apparatus according to the operation condition associated with the treatment unit; and
(B) constructing a model for deriving the operation condition that satisfies the intended characteristic value with respect to each characteristic item, based on a dataset that includes data representing a condition value of each operation item in the operation condition, and data representing the characteristic value with respect to each characteristic item, for each of the treatment units.

2. The operation condition decision support method according to claim 1, the method further causing the computer to perform
(C) deriving an operation condition that satisfies the intended characteristic value with respect to each of the one or more characteristic items, using the model.

3. The operation condition decision support method according to claim 1, wherein in (B),
with respect to each of the plurality of treatment units,
for the treatment unit, if the characteristic values of a predetermined number or more or a predetermined type of characteristic items among the one or more characteristic items satisfy a predetermined requirement, a first label is assigned to the treatment unit,
for the treatment unit, if the characteristic values of the predetermined number or more or the predetermined type of characteristic items among the one or more characteristic items do not satisfy the predetermined requirement, a second label is assigned to the treatment unit, and
the dataset includes data representing the label assigned to the treatment unit, with respect to each of the plurality of treatment units.

4. The operation condition decision support method according to claim 3, wherein
the first label means that the characteristic values of the predetermined number or more or the predetermined type of the characteristic items satisfy a requirement meaning a bad treatment result, and
the second label means that the characteristic values of the predetermined number or more or the predetermined type of the characteristic items do not satisfy the requirement meaning the bad treatment result.

5. The operation condition decision support method according to claim 4, wherein
the treatment apparatus includes a treatment chamber, and treats the treatment unit having entered the treatment chamber,
in (A), with respect to each of the plurality of treatment units, for the treatment unit, values are measured by one or more sensors about each of one or more measurement items concerning an inside of the treatment chamber, and are stored, during treatment according to the operation condition associated with the treatment unit,
in (B),
one or more causes assigned the first label are identified from data that includes a time series of measurements about each of measurement items with respect to each treatment unit assigned the first label, and data that includes a time series of measurements about each of the measurement items with respect to each treatment unit assigned the second label,
each of the one or more causes is a measurement characteristic with respect to one or more measurement items in a common time interval in a measurement time series about each measurement item with respect to each treatment unit assigned the first label, and
based on a relationship between the one or more causes and the operation condition with respect to each treatment unit assigned the first label, the model for deriving the operation condition for preventing the one or more causes from occurring is constructed.

6. The operation condition decision support method according to claim 1, wherein
the treatment apparatus includes a treatment chamber, and treats the treatment unit having entered the treatment chamber,
in (A), with respect to each of the plurality of treatment units, for the treatment unit, values are measured by one or more sensors with respect to each of one or more measurement items concerning an inside of the treatment chamber, and are stored, during treatment according to the operation condition associated with the treatment unit, and
in (B), the model is constructed based on the dataset that includes a time series of measurements about each of the one or more measurement items with respect to each of the treatment units, besides data representing the operation condition and the characteristic value of each characteristic item with respect to each treatment unit.

7. The operation condition decision support method according to claim 6, wherein
the treatment apparatus is a continuous furnace that has a plurality of zones arranged in a conveyance direction in the furnace,
the condition value with respect to at least one operation item in the operation condition is a condition value in each zone, and
the plurality of measurement items include a temperature and a gas concentration.

8. An operation condition decision support system for supporting decision of an operation condition for a treatment apparatus that applies a treatment to one or more treatment target objects included in a treatment unit, the system comprising:
a characteristic value assigning unit that stores data representing a characteristic value obtained about each of one or more characteristic items related to a treatment result of the treatment target object, for each of a plurality of different treatment units with which a plurality of different operation conditions are associated, with respect to the treatment unit treated by the treatment apparatus according to the operation condition associated with the treatment unit; and
a model constructing unit that constructs a model for deriving the operation condition that satisfies the intended characteristic value with respect to each characteristic item, based on a dataset that includes data representing a condition value of each operation item in the operation condition, and data representing the characteristic value with respect to each characteristic item, for each of the treatment units.

9. A computer program for supporting decision of an operation condition for a treatment apparatus that applies a treatment to one or more treatment target objects included in a treatment unit, the program causing a computer to perform:
(A) storing data representing a characteristic value obtained about each of one or more characteristic items related to a treatment result of the treatment target object, for each of a plurality of different treatment units with which a plurality of different operation conditions are associated, with respect to the treatment unit treated by the treatment apparatus according to the operation condition associated with the treatment unit; and
(B) constructing a model for deriving the operation condition that satisfies the intended characteristic value with respect to each characteristic item, based on a dataset that includes data representing a condition value of each operation item in the operation condition, and data representing the characteristic value with respect to each characteristic item, for each of the treatment units.

10. A system comprising:
a treatment apparatus that applies a treatment to one or more treatment target objects included in a treatment unit; and
the operation condition decision support system according to claim 8.
